(19) United States
(12) Patent Application Publication
(10) Pub. No.: US 2012/0058343 A1
(43) Pub. Date: Mar. 8, 2012

(54) Preparation Method Of Hydrophobic Hollow Glass Micro Bead And Hydrophobic Hollow Glass Micro Bead Thereof

(75) Inventors: Lu Lu, Zhejiang (CN); Zhongdi Chen, Zhijiang (CN)

(73) Assignee: Zhejiang Tongda Machinery Co., Ltd., Ruian, Zhejiang (CN)

(21) Appl. No.: 13/266,421

(22) PCT Filed: Jun. 30, 2010
(86) PCT No.: PCT/CN2010/000988

§ 371 Date: Oct. 26, 2011

(30) Foreign Application Priority Data
Feb. 10, 2010 (CN) 201010108307.5

(51) Int. Cl. C03B 19/10; C03C 17/30; B32B 5/16

(52) U.S. Cl. 428/406; 65/21.4

(57) ABSTRACT

A preparation method of low cost hydrophobic hollow glass micro bead by means of spray drying includes the steps of adding an atomized mixed solution of boric acid, potassium hydroxide, lithium hydroxide, and calcium hydroxide into a high-speed stirred water glass solution, spray drying the solution, and then treating the surface of the micro bead with an organic silicon water repellent.

### FIELD OF THE INVENTION

The present invention relates to a preparation technology of low cost hydrophobic hollow glass microsphere, which, specifically, using sodium silicate (water glass), boric acid, potassium hydroxide, lithium hydroxide and calcium hydroxide as raw materials, is obtained by means of adopting low temperature spray drying, and. superficial hydrophobic treating the hollow glass microsphere with organic silicon water repellent in the process of collecting materials to obtain the high quality product in one step, and saving energy consumption.

### BACKGROUND TO THE INVENTION

The hollow glass microsphere, a hollow glass sphere of minute size, belongs to inorganic nonmetallic material, which includes chemical compounds of silicon, boron, calcium, potassium, sodium and oxygen etc. The typical particle size ranges from 5 to 200 μm and bulk density from 100 to 300 kg/m³ with advantages of lightweight, low thermal conductivity, sound insulation, high dispersion, electrical insulation and high heat-stability etc., which is a new lightweight material improved in recent years with wide usage and superior performance. The hollow glass microsphere can be used as fillers of all kinds of composite materials because of the good fluidity and high physical and chemical stability to play a part in reducing the density of the material and improving its processibility. Nowadays, the domestic hollow glass microsphere is mainly extracted from the floater of electrical plant fly ash. The floater has lower hollow ratio and open pore structure, and has high water absorption and oil absorption when used as fillers. The hollow glass microsphere, produced by American 3M Corporation and Potters Industries Inc., can meet the requirement of high strength, high hollow ratio and high stability, but these products can not he widely used because of high import cost. Patent CN1736912A and CN101152978A do not solve the problem of improving the hollow ratio and physical and chemical stability of hollow glass microsphere on preparing technology, and their sintering temperature are all above 1000° C., which waste lots of energy. Patent CN1990410A lowers the sintering temperature to 400-650° C., but increases the energy consumption and does not solve the problem of surface modification by means of second sintering to get products. U.S. Pat. Nos. 4,421,562, 4,340,642, 4,411,847 produce the hollow glass microsphere by means of low temperature spray drying with adding the ammonium borate solution as accessory. Some ammonia gas will be discharged in the process of spray drying and it has certain pollution to the environment. Besides, it is a complex procedure that removing the water on the surface of hollow glass microsphere by means of second drying and proceeding superficial treatment to the hollow glass microsphere with aluminium sulfate and aluminium chloride.

### SUMMARY OF THE INVENTION

The technical problem to be solved of the present invention aims to provide a preparation method of hydrophobic hollow glass microsphere with low cost and low energy consumption. The hydrophobic hollow glass microsphere prepared by this method has the features of high strength, high hollow ratio, high stability and hydrophobicity.

To solve the above technical problem, the present invention uses following technical solutions:

A preparation method of hydrophobic hollow glass microsphere, taking the following steps: mixing the boric acid, potassium hydroxide, lithium hydroxide, calcium hydroxide with water in a mass ratio of 1:0.1˜0.3:0.05˜0.2:0.005˜0.01:5˜8 to dissolve the said solution into the clear and transparent completely to get auxiliary solution. And adding the auxiliary solution into the stirred sodium silicate (water glass) by means of spraying to form colloid, the usage of the quality of sodium silicate (water glass) is 10-20 times of boric acids; and then transporting the colloid to spray drying apparatus to proceed spray drying under the atmospheric pressure to obtain the semi-product of hollow glass microsphere; at last, superficial hydrophobic treating organic silicon water repellent on the surface of the hollow glass microsphere to obtain the said hydrophobic hollow glass microsphere.

The invention uses low temperature spray drying process, selects the low-cost sodium silicate (water glass) as main raw material and uses boric acid, potassium hydroxide, lithium hydroxide and calcium hydroxide mixed solution instead of ammonium borate as accessory, avoiding the pollution to environment in process, which improves the strength, water resistance and physical and chemical stability of the hollow glass microsphere. The invention proceeds superficial treatment by using organic silicon water repellent in the process of collecting materials simultaneously and can complete the whole process of preparation and superficial treatment in one apparatus, which can obtain the hollow glass microsphere with high hydrophobicity by means of one-step process and simplify the process flow and reduce the energy consumption in producing process. Wherein, the boric acid can lower the vitrification point of the hollow glass microsphere thus the energy consumption can be reduced. Potassium hydroxide can be used to increase the alkaline of the solution, which is helpful to dissolve of boric acid in the water. Lithium silicate, produced by lithium hydroxide and sodium silicate (water glass), having self-drying, can improve the water-resistance of hollow glass microsphere. Calcium silicate with high strength, produced by calcium hydroxide and sodium silicate (water glass), can enhance the strength and stability of the hollow glass microsphere. Furthermore, preferably, the feed mass ratio of boric acid, potassium hydroxide, lithium hydroxide, calcium hydroxide and water of the present invention is 1:0.1˜0.2:0.08˜0.15:0.005˜0.01:5˜8: preferably the usage of the quality of the sodium silicate (water glass) is 10-15 times of boric acids. The preparation of the auxiliary solution of the invention do not have special requirement of heating temperature, only the accessories need to be dissolved completely under the heating condition in order to completely dissolve the solid of accessories.

The auxiliary solution is added into the sodium silicate (water glass) by means of spray drying to avoid the local pH value of sodium silicate (water glass) changing greatly and form the irreversible SiO2 precipitate.

The said spray drying of the invention can vitrify the raw material into sphere in 250-400° C. in the presence of the boric acid. The spray drying temperature of the invention preferably is 300-400° C. and outlet temperature is 150-200° C.

The invention uses organic silicon water repellent to superficial hydrophobic treating the semi-product of the hollow glass microsphere that obtained by spray drying. The said organic silicon water repellent can select from aminopropyltriethoxysilane, γ-Glycidoxypropyltrimethoxysilane, γ-(Methacryloloxy)propyltrimethoxysilane and Sodium methylsiliconate, preferably select the Sodium methylsiliconate. The organic silicon water repellent is diluted into dilute solution of the volume concentration of 5-10% with low boiling point organic solvent. The said low boiling point organic solvent selects from ethanol, methanol and acetone, preferably select methanol in the view of low cost.

The adding quality of the said organic silicon water repellent of the invention is 0.02-0.5% of the sodium silicate (water glass).

The preferred process of the invention is that after obtaining the semi-product of the hollow glass microsphere by using spray drying in spray drying apparatus, the said organic silicon water repellent is added into the pipe that located before the cyclone separator by spraying so that the said organic silicon water repellent adhered to the surface of hollow glass microsphere and then separated into cyclone separator to obtain the hydrophobic hollow glass microsphere. Normally, the spray drying apparatus comprises drying chamber and cyclone separator. The drying chamber is connected with cyclone separator via rewind pipeline, the exhaust gas discharged from drying chamber and the hollow glass microsphere semi-product are transported to the cyclone separator to separate via rewind pipe, wherein the exhaust gas are discharged and the particle are collected to the collection barrel. The invention is set a sprinkle-nozzle on the rewind pipeline, the organic silicon water repellent is uniform sprayed to the rewind pipe that located before the cyclone separator, and then mixed with the semi-product of the hollow glass microsphere. The product separated by the cyclone separator fells into the collection barrel and slow cooling to the room temperature to obtained the hydrophobic hollow glass microsphere. According to the above design, the invention can proceed superficial hydrophobic treatment in collecting process of the spray drying apparatus to obtain the high quality hydrophobic hollow glass microsphere in one step. The particle size distribution of the obtained hydrophobic hollow glass microsphere is 30-80 μm and the particle density of it is between 0.20-0.47 g/m³.

Compared with the prior art, the preparation method of hydrophobic hollow glass microsphere provided by the invention uses boric acid, potassium hydroxide, lithium hydroxide, calcium hydroxide as accessory add into the sodium silicate (water glass) by means of atomized mixing, and superficial hydrophobic treating the semi-product with organic silicon water repellent. The advantage is that the invention has simple process, low cost and low energy consumption; the obtained hydrophobic hollow glass microsphere has the characters of high strength, high hollow ratio, high stability and high hydrophobicity. Thus, the said preparation method of hydrophobic hollow glass microsphere of the invention has good prospect for industrial application.

### DETAILED DESCRIPTION OF PREFERRED EMBODIMENTS

Add the boric acid, potassium hydroxide, lithium hydroxide and calcium hydroxide that weighed in proportion into the water to obtain the clear and transparent auxiliary solution. Add the sodium silicate (water glass) into the bottom magnetic force driving agitator for high speed stirring, spray the auxiliary solution into the agitator via the atomized sprinkle-nozzle on the top of agitator to obtain the precursor solution. Then the precursor solution is pumped to the spray drying apparatus for drying via peristaltic pump. The organic silicon water repellent is dissolved in the low boiling point organic solution and uniform sprayed into the rewind pipe that located before the cyclone separator. The organic silicon water repellent and the precursor solution should be synchronously supplied. The product of hydrophobic hollow glass microsphere can be obtained from the bottom of cyclone separator after natural cooling. The product mainly comprises the mixture of hollow glass microsphere, damaged hollow glass microsphere and solid glass microsphere.

The product, having high hydrophobicity, low deposition ratio, high hollow ratio and high physical and chemical stability when placed in water, is a widely used additive such as modifier, reinforcer, curing agent and filler.

The following Table 1 shows twelve different embodiments of the invention.

The sample test to the embodiment 2, the thermal conductivity is 0.043 W/mK, particle size distribution is 40-120 μm, particle density is 0.18 g/m3, and pelletizing rate is 85%.

The sample test to the embodiment 3, the thermal conductivity is 0.045 W/mK, particle size distribution is 30-90 μm, particle density is 0.25 g/m3, and pelletizing rate is 88%.

The sample test to the embodiment 6, the thermal conductivity is 0.05 W/mK, particle size distribution is 60-140 μm, particle density is 0.21 g/m3 and pelletizing rate is 87%.

The sample test to the embodiment 9, the thermal conductivity is 0.046 W/mK, particle size distribution is 30-70 μm, particle density is 0.26 g/m3 and pelletizing rate is 81%.

The sample test to the embodiment 12, the thermal conductivity is 0.048 W/mK, particle size distribution is 40-100 μm, particle density is 0.2 g/m3 and pelletizing rate is 87%.

TABLE 1

| | Sodium | | | | | | | Selected |
|---|---|---|---|---|---|---|---|---|
| | silicate | | | | | | | organic |
| | (Water | Boric | potassium | lithium | calcium | | | solvent |
| Embodi- | glass) | acid | hydroxide | hydroxide | hydroxide | Water | Selected organic silicon water repellent | and |
| ment | amounts | amounts | amount | amount | amount | amount | and amount | amount |
| 1 | 10 kg | 1 kg | 150 g | 100 g | 5 g | 8 kg | Sodium methylsiliconate 10 g | Ethanol |
| | | | | | | | | 100 ml |
| 2 | 10 kg | 1 kg | 180 g | 120 g | 8 g | 6 kg | Sodium methylsiliconate 5 g | methanol |
| | | | | | | | | 100 ml |
| 3 | 12 kg | 1 kg | 160 g | 60 g | 10 g | 5 kg | aminopropyltriethoxysilane 6 g | Ethanol |
| | | | | | | | | 60 ml |
| 4 | 15 kg | 1 kg | 200 g | 160 g | 6 g | 5 kg | Sodium methylsiliconate 10 g | acetone |
| | | | | | | | | 90 ml |
| 5 | 18 kg | 1 kg | 180 g | 50 g | 5 g | 5 kg | aminopropyltriethoxysilane 10 g | Ethanol |
| | | | | | | | | 100 ml |
| 6 | 20 kg | 1 kg | 300 g | 200 g | 10 g | 8 kg | γ-Glycidoxypropyltrimethoxysilane 10 g | acetone |
| | | | | | | | | 100 ml |
| 7 | 15 kg | 1 kg | 260 g | 80 g | 10 g | 7 kg | γ-Glycidoxypropyltrimethoxysilane 8 g | methanol |
| | | | | | | | | 100 ml |
| 8 | 16 kg | 1 kg | 230 g | 150 g | 5 g | 5 kg | γ-(Methacryloloxy)propyltrimethoxysilane 10 g | Ethanol |
| | | | | | | | | 100 ml |
| 9 | 14 kg | 1 kg | 120 g | 180 g | 10 g | 8 kg | γ-(Methacryloloxy)propyltrimethoxysilane 7 g | acetone |
| | | | | | | | | 90 ml |
| 10 | 12 kg | 1 kg | 100 g | 70 g | 5 g | 5 kg | Sodium methylsiliconate 8 g | acetone |
| | | | | | | | | 100 ml |
| 11 | 11 kg | 1 kg | 140 g | 50 g | 4 g | 5 kg | aminopropyltriethoxysilane 3 g | Ethanol |
| | | | | | | | | 40 ml |
| 12 | 17 kg | 1 kg | 100 g | 70 g | 5 g | 5 kg | Sodium methylsiliconate 4 g | acetone |
| | | | | | | | | 50 ml |

| | Spray | Spray | Product's | | | |
|---|---|---|---|---|---|---|
| | drying | drying | particle | | | Product's |
| | inlet air | outlet air | size | Product's | | precipi- |
| | temper- | temper- | distri- | particle | | tation |
| Embodi- | ature | ature | bution | density | Product's | coefficient |
| ment | (° C.) | (° C.) | (μm) | (g/cm³) | hydrophilicity | (%) |
| 1 | 350 | 170 | 30~80 | 0.29 | hydrophobic | N/A |
| 2 | 400 | 250 | 40~120 | 0.18 | hydrophobic | N/A |
| 3 | 360 | 180 | 30~90 | 0.25 | hydrophobic | N/A |
| 4 | 380 | 160 | 20~70 | 0.36 | hydrophobic | N/A |
| 5 | 280 | 150 | 10~40 | 0.47 | hydrophobic | 1.5% |
| 6 | 500 | 170 | 60~140 | 0.21 | hydrophobic | 2.0% |
| 7 | 200 | 130 | 10~40 | 0.55 | hydrophobic | 1.8% |
| 8 | 300 | 140 | 15~50 | 0.42 | hydrophobic | 1.2% |
| 9 | 340 | 180 | 30~70 | 0.26 | hydrophobic | N/A |
| 10 | 450 | 160 | 20~90 | 0.22 | hydrophobic | N/A |
| 11 | 250 | 120 | 10~40 | 0.57 | hydrophobic | 1.4% |
| 12 | 480 | 220 | 10~100 | 0.2 | hydrophobic | N/A |

1. A preparation method of hydrophobic hollow glass microsphere comprising: preparing the borate solution, mixing the solution with sodium silicate (water glass) and forming the colloid; then spray drying the colloid and superficial treatment to the semi-product; characterized in that it specifically comprising the following steps: mixing the boric acid, potassium hydroxide, lithium hydroxide, calcium hydroxide with water in a mass ratio of 1:0.1˜0.3:0.05˜0.2:0.005˜0.01:5˜8 to dissolve the said solution into the state of clear and transparent completely, getting auxiliary solution; and adding the auxiliary solution into the stirred sodium silicate (water glass) by means of spraying to form colloid, the usage of the quality of sodium silicate (water glass) is 10-20 times of boric acids; and then transporting the colloid to spray drying apparatus to proceed spray drying under the atmospheric pressure to obtain the semi-product of hollow glass microsphere; at last, superficial hydrophobic treating the organic silicon water repellent on the surface of the hollow glass microsphere to obtain the said hydrophobic hollow glass microsphere.

2. A preparation method of hydrophobic hollow glass microsphere in accordance with claim 1, wherein the setting drying temperature of the said spray drying is 250-400° C., the outlet air temperature is 120-200° C.

3. A preparation method of hydrophobic hollow glass microsphere in accordance with claim 1, wherein the organic silicon water repellent is selected at least one from which of the aminopropyltriethoxysilane, γ-Glycidoxypropyltrimethoxysilane, γ-(Methacryloloxy)propyltrimethoxysilane and Sodium methylsiliconate.

4. A preparation method of hydrophobic hollow glass microsphere in accordance with claim 3, wherein the organic silicon water repellent is Sodium methylsiliconate.

5. A preparation method of hydrophobic hollow glass microsphere in accordance with claim 1, wherein the adding quality of organic silicon water repellent is 0.02˜0.5% of the sodium silicate (water glass).

6. A preparation method of hydrophobic hollow glass microsphere in accordance with claim 1, wherein the organic silicon water repellent is added into the pipe that located before the cyclone separator by means of spraying so that the said organic silicon water repellent adhered to the surface of hollow glass microsphere and then separated into cyclone separator to obtain the hydrophobic hollow glass microsphere.

7. Hydrophobic hollow glass microsphere prepared by a preparation method with claim 1.

8. A preparation method of hydrophobic hollow glass microsphere in accordance with claim 7, wherein the particle size distribution is 30-80 μm.

9. A preparation method of hydrophobic hollow glass microsphere in accordance with claim 7, wherein the particle density is between 0.20-0.47 g/m³.
